(19) United States
(12) Patent Application Publication
(10) Pub. No.: US 2012/0279628 A1
(43) Pub. Date: Nov. 8, 2012

(54) MULTIPLE BEAD RADIAL TIRE

(76) Inventor: Maurice Taylor, Naples, FL (US)

(21) Appl. No.: 13/288,160

(22) Filed: Nov. 3, 2011

Related U.S. Application Data
(63) Continuation-in-part of application No. 12/354,711, filed on Jan. 15, 2009, now abandoned.
(60) Provisional application No. 61/021,328, filed on Jan. 15, 2008.

(51) Int. Cl. B60C 15/05

(52) U.S. Cl. 152/545

(57) ABSTRACT

A radial tire is provided for use with off-the-road (OTR) vehicles. The tire includes multiple beads, a nylon carcass and multiple nylon plies. The construction prevents slipping and rocking, and zipper-type failures. The tire also has improved lateral stability under load.

This application claims priority to U.S. patent application Ser. No. 61/021,328 filed Jan. 15, 2008 and U.S. patent application Ser. No. 12/354,711, filed Jan. 15, 2009, which are incorporated herein by this reference.

### BACKGROUND OF THE INVENTION

1. Field

The present invention relates generally to Off-the-Road (OTR) radial tires and, more specifically, OTR radial tires with multiple beads and a non-steel carcass.

2. Background

Off-the-Road (“OTR”) tires are used for construction vehicles such as wheel loaders, backhoes, graders, trenchers, and mining vehicles. OTR tires are typically radial tires, which use body ply cords extending from beads on opposite sides of the tire and across the tread so that the cords are laid at approximately right angles to the centerline of the tread, and parallel to each other.

Typically, OTR tires are steel-belted, singled ply, with one bead on each side of the tire. These tires are often required to sustain heavy loads and frequently are subjected to extreme torque and torsion, which causes them to regularly experience rocking, slipping and erosions, and can cause rapid air loss through sidewall zippering.

Multiple-bead bias tires are disclosed in the prior art. For example, U.S. Pat. No. 4,029,137 to Suydam discloses the use of multiple-bead bias tires for aircraft. A bias tire utilizes body ply cords that extend diagonally from bead to bead, usually at angles in the range of 30 to 40 degrees, with successive plies laid at opposing angles forming a crisscross pattern to which the tread is applied. Radial tires, however, utilize body ply cords in the carcass that extend horizontally around the beads to promote greater rigidity and surface contact area.

Therefore, there is a need in the art for a multiple-bead radial tire for use in OTR applications.

### SUMMARY OF THE INVENTION

The object of the present invention is to provide a novel Off-the-Road tire.

A further object of the present invention is to provide a multiple bead Off-the-Road radial tire.

Another object of the present invention is to provide a radial tire with multiple non-steel plies.

To that end, a multiple bead Off-the-Road radial tire is provided. The tire is constructed with multiple non-steel body plies and steel belts. A plurality of the cords are wrapped at varying non-ninety degree angles to prevent cord nesting and allow for the multiple bead radial construction.

### BRIEF DESCRIPTION OF THE DRAWINGS

FIG. 1 shows a cutaway schematic of a traditional bias tire.

FIG. 2 shows a cutaway of the multiple-bead bias tire disclosed by Suydam.

FIG. 3 shows a cutaway comparison of bias and radial tires.

FIG. 4 shows a schematic of a typical single-bead radial tire.

FIG. 5 shows a cutaway photograph of one embodiment of the present invention.

FIG. 6 shows a cutaway photograph of one embodiment of the present invention.

FIG. 7 shows a cutaway photograph of one embodiment of the present invention.

FIG. 8 shows a cutaway photograph of one embodiment of the present invention.

### DETAILED DESCRIPTION OF THE INVENTION

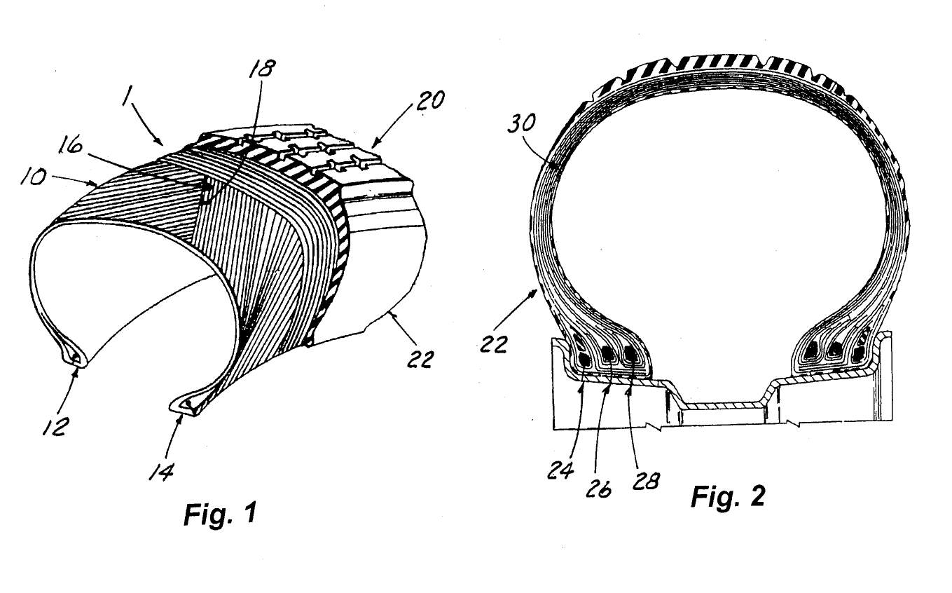

FIGS. 1-2 show bias tires. FIG. 1 shows a typical bias tire 1, which utilizes body ply cords 10 that extend diagonally from bead to bead 12, 14, usually at angles in the range of 30 to 40 degrees from perpendicular to the direction of travel, with successive plies 16 laid at opposing angles forming a crisscross pattern 18 to which the tread is applied 20, resulting in generally rounded sides 22. FIG. 2 shows the multiple-bead 24, 26, 28 bias tire disclosed by Suydam (U.S. Pat. No. 4,029,137), which contains bias plies 30.

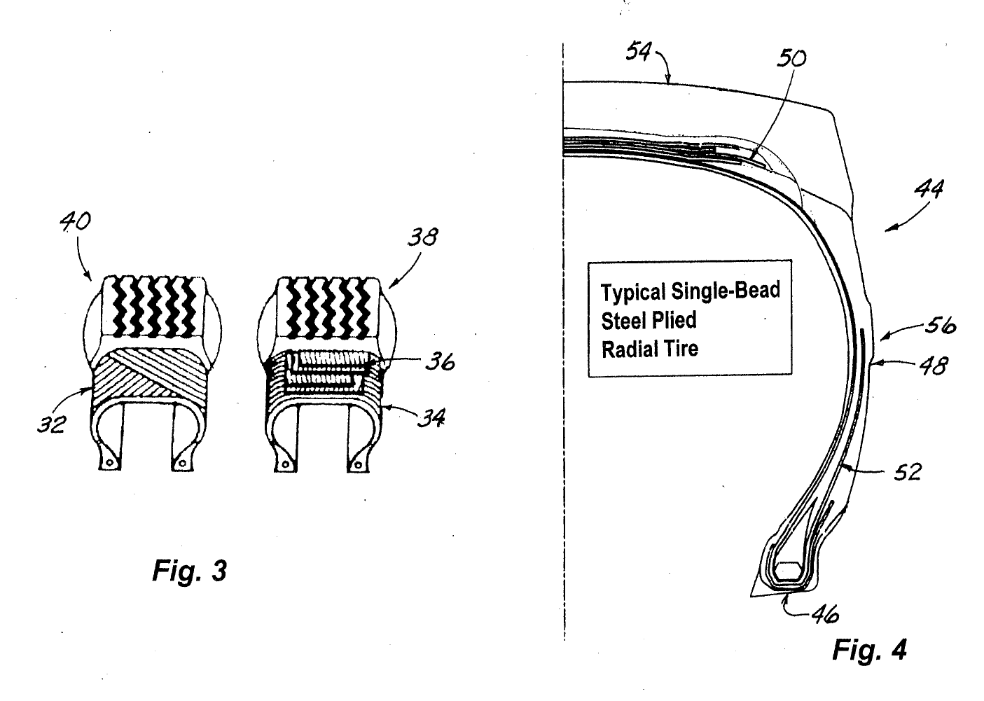

FIGS. 3-4 show radial tires. FIG. 3 shows the different orientations of body plies 32, 34 in a typical bias tire 40 and a typical radial tire 38, along with a radial steel belt 36. FIG. 4 shows an example of a typical prior art Off-the-Road (OTR) radial tire 44, with a single bead 46, generally rigid sidewalls 48, and steel belts 50. FIGS. 3-4 show that radial tires use body ply cords 52 extending from beads 46 on opposite sides of the tire and across the tread 54 so that the cords are laid at approximately right angles to the centerline of the tread, and parallel to each other 34. These OTR radial tires utilize body ply cords 52 in the carcass 56 that extend horizontally around the beads 46 to promote greater rigidity in the sidewalls 48 and greater surface contact area of the tread 54. Radial OTR tires are used for construction vehicles such as wheel loaders, backhoes, graders, trenchers, and mining vehicles. These tires are often required to sustain heavy loads and frequently are subjected to extreme torque and torsion, which causes them to regularly experience rocking, slipping and erosions, and can cause rapid air loss through sidewall zippering.

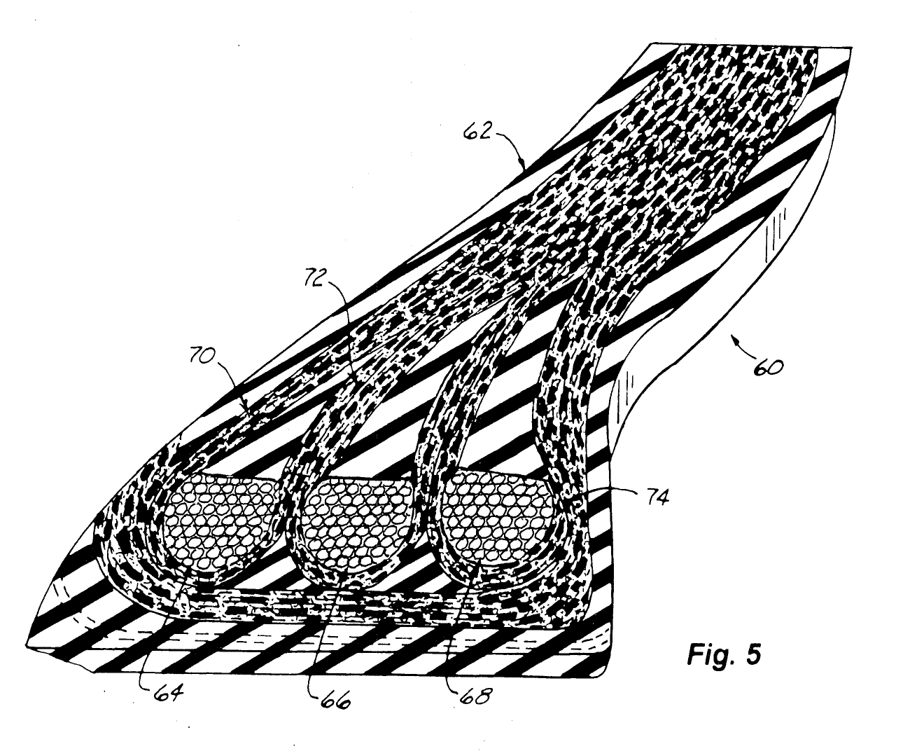

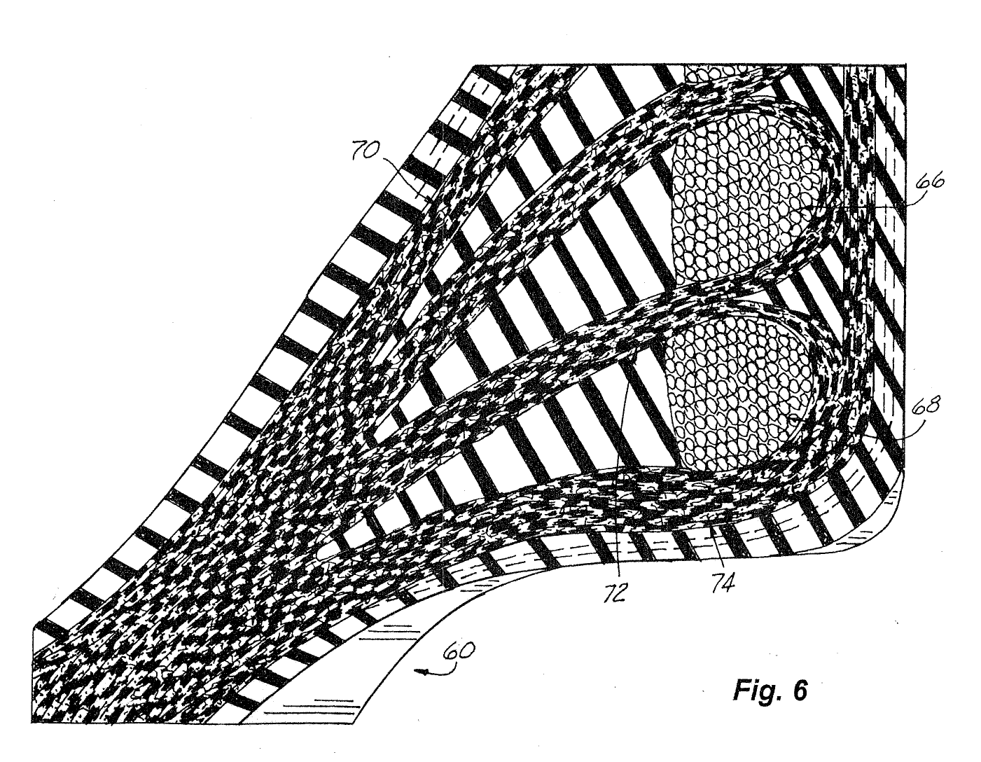

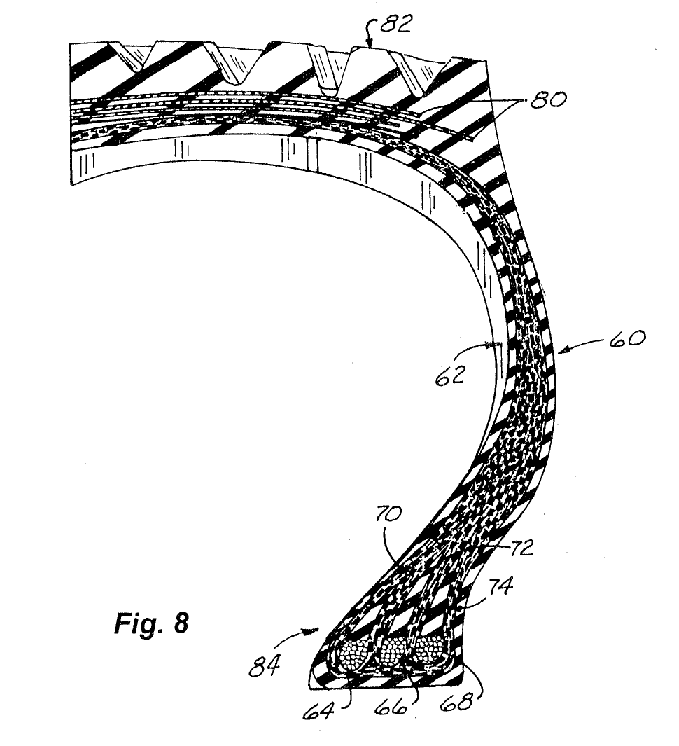

FIGS. 5-8 show cutaway images of the multi-bead, multi-plied OTR radial tire 60 of the present invention. As shown in FIGS. 5-8, the OTR radial tire 60 includes a carcass 62. In one embodiment, shown in FIGS. 5-8, the OTR radial tire 60 is used in mining operations. The OTR of the present invention radial tire has at least two beads 64, 66, and in the embodiment shown in FIGS. 5,6 and 8 has a third bead 68. The tire of the present invention may have four, five, six, or more beads, and bead cores may be used. As best shown in FIG. 6, the tire 60 has multiple nylon or other elastic non-steel body plies 70, 72, 74. As best shown in FIG. 6, these body plies are typically continuous around the beads 64, 66, 68 and of varying lengths, as shown in FIG. 8. In an alternate embodiment, the plies are not continuous.

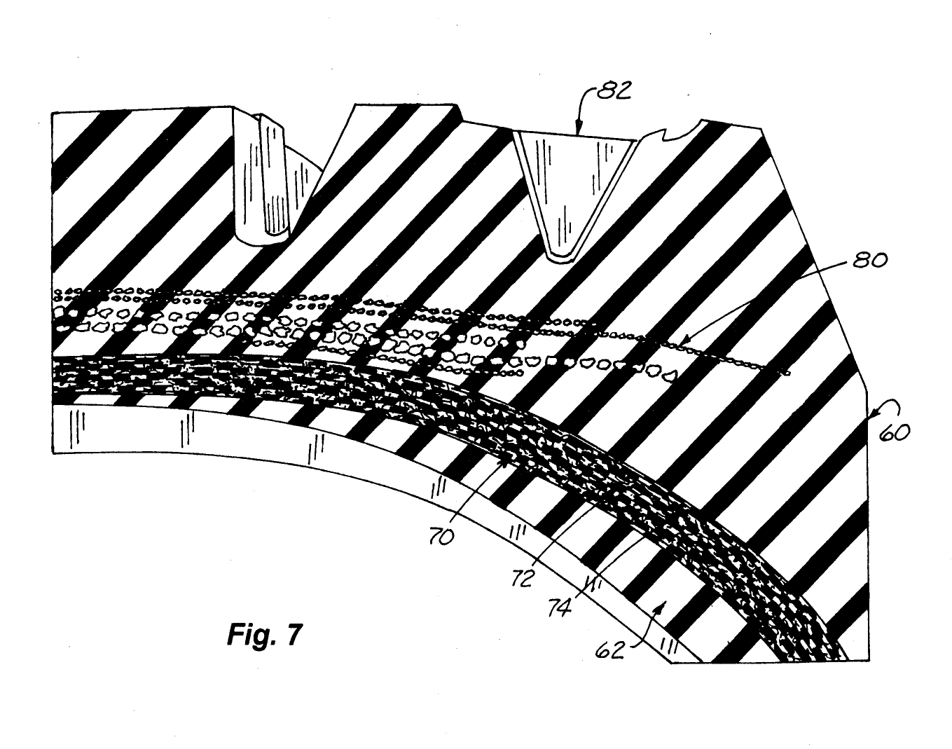

FIG. 7-8 show that in this embodiment, the multi-bead radial tire 60 with non-steel plies 70, 72, 74 has steel belts 80 below the tread 82. In the present invention, the body plies 70, 72, 74 are arranged at angles slightly divergent from the zero degree angle found in the typical radial tires shown in FIGS. 3-4. The belts 80 are typically steel, and multi-bead construction is made possible by layering the plies 70, 72, 74 at angles slightly divergent from the zero degree angle found in typical radial tires, for example two, four, six, or eight degrees from perpendicular). This defeats the recognized problem in the art of parallel ply cords nesting between each other, and avoids rubber flow between the plies. Further, in the present invention, as shown in FIG. 8, the non-steel ply beads 64, 66, 68 are wider than steel-to-steel beads, which allows for more wire bearing surface at the rim contact point 84.

Together, these advancements allow for multiple bead construction in the radial setting, and also causes the carcass to run cooler than steel body plies and not be subject to heat generation caused by the flexing of steel body plies. The non-steel ply-based carcass is also less rigid than a steel body ply because it has greater elongation properties. In the event that the tire of the present invention is extremely overloaded, the tire will lose air and will not experience rapid air loss like a steel-plied tire because nylon and the other non-steel materials contemplated are capable of greater elongation than steel which eliminates the potential for extreme loading of a single cord.

There are several advantages to the multi-bead multi-plied radial OTR design with nylon carcass. The multiple bead construction provides a larger contact area between the beads and wheel to prevent slipping and rocking, as compared to a single bead construction. The tire construction works with any bead taper angle from 0 to 45 degrees. This construction allows for load and operational improvements due to the multiple beads being able to have uniform carrying ability, due to the plies having a greater elongation ability over steel body plies. The multiple bead OTR tire has improved lateral stability under load compared to a standard steel body ply tire.

The multi-ply carcass of the present invention has an improved sidewall resistance to cutting over a standard single ply steel carcass due to the thickness of the carcass of the present invention. The multi-ply elastic carcass is not subject to heat generation caused by the steel body plies flexing so the carcass also runs cooler than tires with steel body plies. The multi-ply carcass is also safer than a steel body ply because non-steel materials such as nylon have greater elongation and less rigidity than steel. The present carcass eliminates the potential for the extreme loading of a single cord resulting in rapid air loss. In addition, the present carcass is safer than the steel body ply tire because there is no potential for zipper type rapid air losses, which are common for steel body ply tires.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1. An Off-the-Road radial tire comprising:
a) a pair of sidewall portions disposed on each side of a midcircumferential plane of the tire, each having a bead area within the sidewall portion;
b) a plurality of beads disposed within each of the bead areas; and
c) a carcass, wherein the carcass further comprises a plurality of non-steel cord plies wrapped around the beads;

2. The radial tire of claim 1, wherein the plurality of body plies are nylon.

3. The radial tire of claim 1, wherein some or all of the cord plies are at angles other than ninety degrees from the direction of travel.

4. The radial tire of claim 1, further comprising steel belts.

5. The radial tire of claim 1, wherein the plurality of body plies are elastic.
